(19) United States
(12) Patent Application Publication
(10) Pub. No.: US 2002/0145832 A1
(43) Pub. Date: Oct. 10, 2002

(54) Perpendicular magnetic recording head with soft underlayer biasing

(75) Inventors: Michael A. Seigler, Pittsburgh, PA (US); Dieter K. Weller, Gibsonia, PA (US); Robert E. Rottmayer, Wexford, PA (US)

Correspondence Address: Benjamin T. Queen, II, Pietragallo, Bosick & Gordon, One Oxford Centre, 38th Floor, 301 Grant Street, Pittsburgh, PA, 15219, US

(73) Assignee: Seagate Technology LLC, Scotts Valley, CA

(21) Appl. No.: 10/109,465

(22) Filed: Mar. 28, 2002

Related U.S. Application Data
(60) Provisional application No. 60/281,430, filed on Apr. 4, 2001.

(51) Int. Cl. G11B 5/39

(52) U.S. Cl. 360/313

(57) ABSTRACT

A perpendicular magnetic recording head includes a read head having means for generating a magnetic field which reduces noise from a soft magnetic underlayer of a recording medium during operation of the recording head. The means for generating a magnetic field includes a current perpendicular to the plane read sensor of the read head. The electrical current generates a magnetic field which biases the magnetization of the soft magnetic underlayer. By controlling the amount of current or current density that is passed through the read sensor, the magnitude of the magnetic field for biasing the soft magnetic underlayer may be controlled. A method of using a perpendicular magnetic recording head to magnetically bias a soft magnetic underlayer of a recording medium is also disclosed.

### CROSS REFERENCE TO RELATED APPLICATION

This application claims the benefit of U.S. Provisional Application No. 60/281,430 filed Apr. 4, 2001.

### FIELD OF THE INVENTION

The invention relates to perpendicular magnetic recording, and more particularly, to a perpendicular magnetic recording head for biasing the soft underlayer of a perpendicular magnetic recording medium.

### BACKGROUND OF THE INVENTION

Perpendicular magnetic recording systems have been proposed for use in computer hard disc drives. A perpendicular recording head may include a trailing write pole, a leading return or opposing pole magnetically coupled to the write pole, and an electrically conductive magnetizing coil surrounding the yoke of the write pole. Perpendicular recording media may include a hard magnetic recording layer with vertically oriented magnetic domains and a soft magnetic underlayer to enhance the recording head fields and provide a flux path from the trailing write pole to the leading or opposing pole of the writer. Such perpendicular recording media may also include a thin interlayer between the hard recording layer and the soft underlayer to prevent exchange coupling between the hard and soft layers.

To write to the magnetic recording medium, the recording head is separated from the magnetic recording medium by a distance known as the flying height. The magnetic recording medium is moved past the recording head so that the recording head follows the tracks of the magnetic recording medium, with the magnetic recording medium first passing under the opposing pole and then passing under the write pole. Current is passed through the coil to create magnetic flux within the write pole. The magnetic flux passes from the write pole tip, through the hard magnetic recording track, into the soft underlayer, and across to the opposing pole.

In addition, the soft underlayer helps during the read operation. During the read back process, the soft underlayer produces the image of magnetic charges in the magnetically hard layer, effectively increasing the magnetic flux coming from the medium. This provides a higher playback signal.

Perpendicular recording designs have the potential to support much higher linear densities than conventional longitudinal designs. In addition, the described bilayer medium is used in perpendicular recording to provide increased efficiency of the recording head. The soft magnetic underlayer of the perpendicular recording medium forms inverse image charges and substantially magnifies both the write field during recording and the fringing field of the recorded transition during reproduction.

One of the challenges of implementing perpendicular recording is to resolve the problem of soft underlayer noise. The noise may be caused by fringing fields generated by magnetic domains, or uncompensated magnetic charges, in the soft underlayer that can be sensed by the reader. For example, soft underlayer materials, such as Ni₈₀Fe₂₀ or Co₉₀Fe₁₀, may exhibit multi-domain states that produce noise enhancement in the read-back signals, hence, degrading the signal-to-noise (SNR) ratio. If the magnetic domain distribution of such materials is not carefully controlled, very large fringing fields can introduce substantial amounts of noise in the read element.

There have been proposed solutions for solving the noise problem that results from utilizing the soft underlayer. The proposed solutions can be generally grouped into media solutions and systems solutions. Many proposed solutions have in common, for example, that a magnetic field is used to bias or hold the soft underlayer magnetization in place, preferably in a radia, cross-track direction. The magnetic bias field can be an internal field generated by, for example, magnetic anisotropy, an exchange bias, or it can be externally supplied through an additional field coil or permanent magnet. An example of a proposed media solution includes using an antiferromagnetic material under or adjacent the soft magnetic underlayer to bias the soft magnetic underlayer, which is sometimes referred to as an exchange biased soft underlayer. Another example of the proposed media solution is using a permanent magnet adjacent to or under the soft magnetic underlayer to provide the biasing effect, which is sometimes referred to as hard biasing. An example of a proposed systems solution is use of an external electromagnet to apply a bias field to the soft magnetic underlayer.

There is still, however, a need for an improved perpendicular magnetic recording system that provides an improved or more effective means for biasing the soft underlayer to reduce or minimize the problem of the soft underlayer noise.

### SUMMARY OF THE INVENTION

The invention meets the identified need, as well as other needs, as will be more fully understood following a review of this specification and drawings.

In accordance with an aspect of the invention, a perpendicular magnetic recording head for use in conjunction with the perpendicular magnetic recording medium having a soft magnetic underlayer comprises a read head including means for generating a magnetic field to bias the magnetization of the soft magnetic underlayer during a read operation of the perpendicular recording head. The means for generating a magnetic field may include a current perpendicular to the plane read sensor.

In accordance with an additional aspect of the invention, a magnetic disc drive storage system comprises a perpendicular magnetic recording medium including a soft magnetic underlayer and a perpendicular magnetic recording head positioned adjacent the perpendicular magnetic recording medium. The perpendicular magnetic recording head includes a read sensor which generates a magnetic field to bias the magnetization of the soft magnetic underlayer of the perpendicular magnetic recording medium during operation of the perpendicular magnetic recording head.

In accordance with a further aspect of the invention, a method of using a perpendicular magnetic recording head, having a read sensor, to magnetically bias a soft magnetic underlayer of a perpendicular magnetic recording medium comprises positioning the read sensor adjacent the recording medium and passing an electrical current through the read sensor which generates a magnetic field to magnetically bias the soft magnetic underlayer to reduce noise from the soft underlayer during a read operation of the recording head. The method may also include controlling the amount of electrical current passing through the read sensor to control the magnitude of the magnetic field to bias the soft underlayer. The method may also include adjusting the magnetic field to maximize the signal-to-noise ratio during a read back process.

### BRIEF DESCRIPTION OF THE DRAWINGS

FIG. 1 is a pictorial representation of a disc drive constructed in accordance with the invention.

FIG. 2 is a partially schematic side view of a perpendicular magnetic recording head and a perpendicular magnetic recording medium in accordance with the invention.

FIG. 3 is a partially schematic isometric view of a portion of the perpendicular magnetic recording head and the perpendicular magnetic recording medium illustrated in FIG. 2.

FIG. 4 is a graphical illustration of an x component of the magnetic field versus cross-track location and a distance from an air-bearing surface.

FIG. 5 is a graphical illustration of a y component of the magnetic field versus cross-track location and a distance from an air-bearing surface.

### DETAILED DESCRIPTION OF THE INVENTION

The invention provides a perpendicular magnetic recording head for biasing a soft magnetic underlayer of a recording medium to reduce noise from the soft magnetic underlayer during operation of the recording head. The invention is particularly suitable for use with a magnetic disc storage system. A recording head, as used herein, is defined as a head capable of performing read and/or write operations

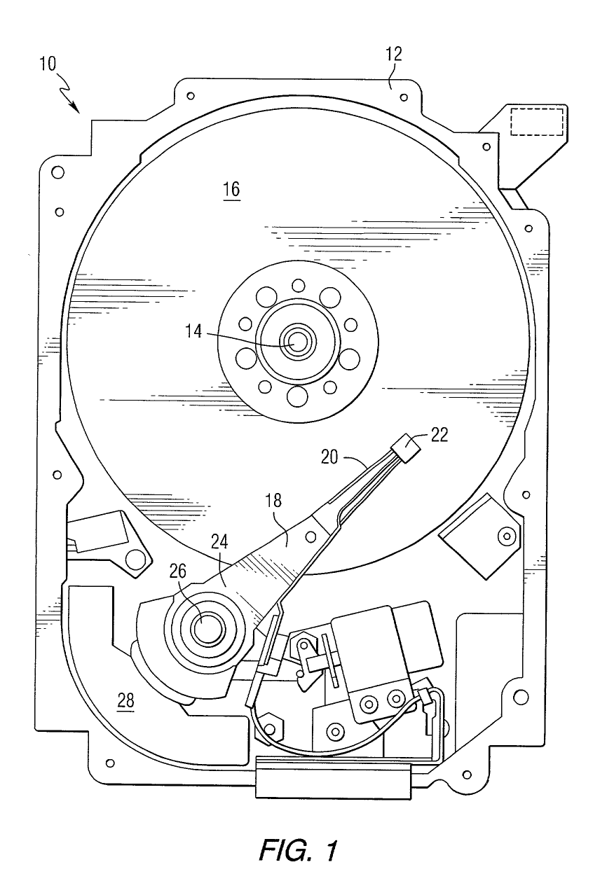

FIG. 1 is a pictorial representation of a disc drive 10 that can utilize a perpendicular recording medium in accordance with this invention. The disc drive 10 includes a housing 12 (with the upper portion removed and the lower portion visible in this view) sized and configured to contain the various components of the disc drive. The disc drive 10 includes a spindle motor 14 for rotating at least one magnetic storage medium 16, which may be a perpendicular magnetic recording medium, within the housing, in this case a magnetic disc. At least one arm 18 is contained within the housing 12,with each arm 18 having a first end 20 with a recording head or slider 22, and a second end 24 pivotally mounted on a shaft by a bearing 26.

An actuator motor 28 is located at the arm's second end 24 for pivoting the arm 18 to position the recording head 22 over a desired sector or track of the disc 16. The actuator motor 28 is regulated by a controller, which is not shown in this view and is well known in the art.

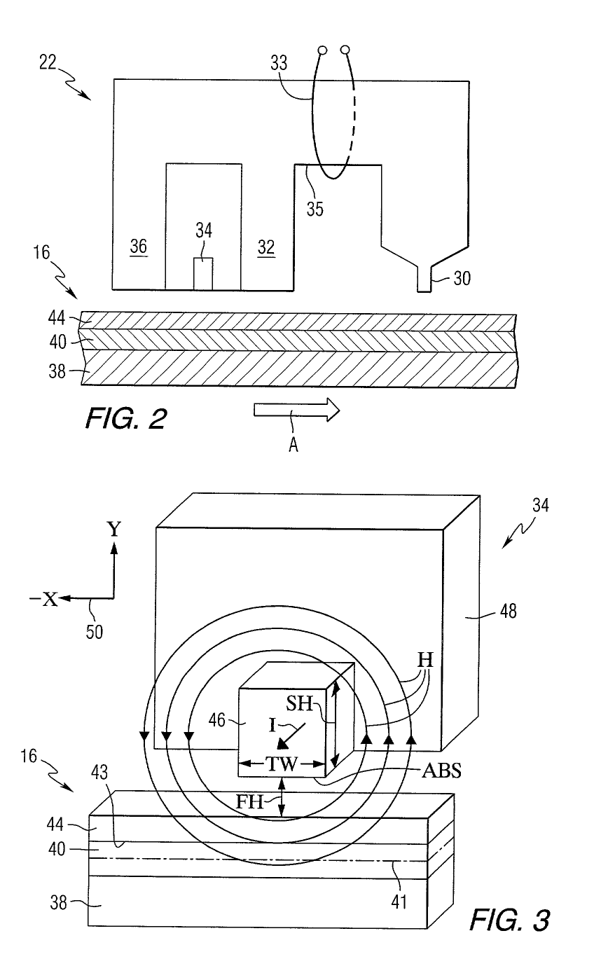

FIG. 2 is a partially schematic side view of the perpendicular magnetic recording head 22 and the perpendicular recording magnetic medium 16. The recording head 22 includes a writer section comprising a trailing main pole 30 and a return or opposing pole 32. A magnetizing coil 33 surrounds a yoke 35, which connects the main pole 30 and return pole 32. The recording head 22 also includes a read head 34 positioned between a reader pole 36 and the opposing pole 32. In the embodiment shown in FIG. 2, the read head 34 shares the opposing pole 32 of the writer section.

Still referring to FIG. 2, the perpendicular magnetic recording medium 16 is positioned under the recording head 22. The recording medium 16 travels in the direction of arrow A during recording. The recording medium 16 includes a substrate 38, which may be made of any suitable material such as ceramic glass, amorphous glass, or NiP plated AlMg. A soft magnetic underlayer 40 is deposited on the substrate 38. The soft magnetic underlayer 40 may be made of any suitable material such as, for example, FeCoB, FeAlN, NiFe, CoZrNb, or FeCo. In addition, the soft underlayer 40 may have a thickness from about 50 nm to about 400 nm. A hard magnetic recording layer 44 is deposited on the soft underlayer 40. Suitable hard magnetic materials for the hard magnetic recording layer 44 may include, for example, CoCr, FePd, CoPd, CoFePd, and CoCrPd. The hard magnetic layer 44 may have a thickness from about 8 nm to about 40 nm.

Referring to FIG. 3, there is illustrated a partial schematic isometric view of the read head 34. Specifically, the read head 34 includes a read sensor 46 positioned adjacent to or in contact with a magnetic shield 48. The magnetic shield 48 may also serve as an electrical lead for passing a current I through the read sensor 46. An additional magnetic shield/lead may be positioned on an opposing side of the read sensor 46, but is not shown in FIG. 3 for simplicity.

The read sensor 46 may be a current perpendicular to the plane (CPP) type sensor wherein the current I flows perpendicular to the plane of the films which form the read sensor 46. However, it will be appreciated, that the read sensor 46 may be constructed as other type sensors, provided that the sensor is capable of generating a large enough magnetic field for biasing the soft magnetic underlayer 40, as will be described herein. In addition, it will be appreciated that the particular material choice for the underlayer 40 and the magnetic properties thereof (such as, for example, the Hk anisotropy field value) will have a direct relationship with the strength of the magnetic field that is needed to provide the desired biasing.

For purposes of illustrating and describing the invention herein, the read sensor 46 will be considered a CPP type sensor. The CPP type sensor 46 is in direct contact with the shields/contacts 48 which act as large heat sinks. This allows the CPP type sensor 46 to operate at a large current density, for example greater than about 1×10⁸ A/cm². At the dimensions of interest for high density recording, for example less than about 100 nm device widths, the current can be substantially uniform across the CPP sensor 46. In a CIP spin-valve sensor, the current density is only this high in the very thin, 2.5 nm, Cu interlayer. The field for biasing the soft underlayer 40 needs to be relatively high, for example greater than about 25 Oe, at about 5-100 nm from the air-bearing surface of the read head 24. The rate at which the magnetic field generated by the current through sensor 46 decreases versus distance from the air-bearing surface depends on the sensor 46 width, and the wider the sensor 46 the slower the magnetic field decreases. This allows for larger magnetic fields to be applied to the soft underlayer 40 via the CPP sensor 46 (multilayer or spin-valve) than the CIP spin-valve.

For the CPP type read sensor 46, as described, the magnetic shield 48 may also serve as an electrical lead that carries the current I to and/or from the sensor 46. Preferably, the shield 48 is in direct contact with the read sensor 46. The magnetic shield 48, in turn, acts as a large heat sink, which allows for much higher current densities to be passed through the sensor 46 without overheating the sensor 46. The current I passing through read sensor 46 results in the generation of a magnetic field H. The magnitude of the magnetic field H is proportional to the amount of current I, and particularly to the current density, that passes through the read sensor 46. For example, an increased current I or increased current density will result in the magnetic field H having an increased magnitude. With the magnetic shield 48 acting as a large heat sink, larger magnetic fields H may be generated by the read sensor 46.

As described herein, one of the challenges of implementing perpendicular magnetic recording is to resolve or minimize the problem of noise from the soft underlayer 40.

The read sensor 46 advantageously generates a magnetic field, such as the magnetic field H illustrated in FIG. 3, which reduces noise from the soft magnetic underlayer 40 during operation of the read head 34. Specifically, the magnetic field H generated by the read sensor 46 as a result of the current I that passes therethrough magnetically biases the soft underlayer 40, by holding or biasing the magnetic domains of the soft underlayer 40 in a desired, uniform direction. Preferably, the magnetic domains of the soft underlayer 40 are biased substantially in a radial cross-track direction.

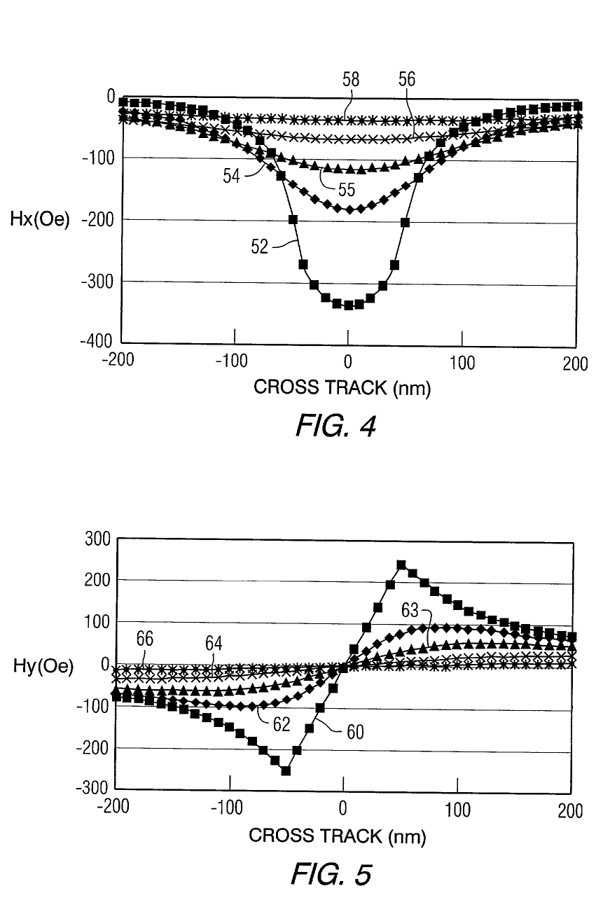

To illustrate the invention, and particularly the magnetic field H applied to the soft magnetic underlayer 40, reference is made to FIGS. 4 and 5 which set forth a graphical illustration of the variation of the x and y components, respectively, of the magnetic field H versus cross-track location and a distance from the air-bearing surface (ABS). The x and y directions are indicated by coordinate system 50 in FIG. 3. The results set forth in FIGS. 4 and 5 are for a sensor 46 having, for example, a track width TW (for modeling purposes the sensor can be considered infinitely long), a stripe height SH of 50 nm and a current density of ˜1.5×10⁸ A/cm². Specifically, line 52 represents a distance of 0 nm from the ABS of the sensor 46, line 54 represents a distance of 50 nm from the ABS, line 55 represents a distance of 100 nm from the ABS, line 56 represents a distance of 200 nm from the ABS, and line 58 represents a distance of 400 nm from the ABS. In FIG. 5, line 60 represents a distance of 0 nm from the ABS of the sensor 46, line 62 represents a distance of 50 nm from the ABS, line 63 represents a distance of 100 nm from the ABS, line 64 represents a distance of 200 nm from the ABS, and line 66 represents a distance of 400 nm from the ABS.

For illustrating the effect of the magnetic field H, the following assumptions can be made: a head to media spacing or flying height FH of 10-15 nm, the hard magnetic recording layer 44 having a thickness of 20 nm and the soft magnetic underlayer 40 having a thickness of 200 nm. Based on these dimensions and as illustrated in FIG. 4, the x component of the magnetic field H directly under the read sensor 46 and at the top of the soft underlayer 40 would be approximately −240 Oe and the magnetic field H at the center 41 of the soft underlayer 40 would be approximately −66 Oe. Based on the results of other techniques employed for biasing a soft underlayer to reduce noise, the results of the biasing provided by the magnetic fields of the present invention were determined to be of the same order or larger than known techniques. In addition, the magnetic field H, in both the x and y directions, is not large enough to effect a high coercivity media as illustrated in FIGS. 4 and 5.

Accordingly, it will be appreciated that the present invention provides an effective means for generating a magnetic field to bias the magnetization of the soft underlayer 40 which reduces noise from the soft underlayer 40 of the recording medium 16. In use, the read head 34, and particularly the read sensor 46, is positioned adjacent the recording medium 16. By controlling the current I, and the current density as well, which flows through the read sensor 46, the magnetic field H emanating from the read sensor 46 can also be controlled. By providing for a larger current I, larger signals may be produced by the read sensor 46 as well as larger magnetic fields H. Advantageously, by controlling the current through the read sensor 46 to bias the magnetization of the soft underlayer 40, an efficient and effective means is provided for biasing the magnetization of the soft layer. Advantageously, this allows for biasing the soft underlayer without the need for additional components, such as a permanent magnet, being formed as part of the recording head and, more specifically, as part of the read head.

It has been determined that a maximum current density that can be run through the read sensor 46 before the signal begins to decrease exists. However, because it is important to increase the signal-to-noise ratio (SNR) of the recording system, an even higher current density may be run through the read sensor 46 to further decease the noise from the soft underlayer 40 and therefore increase the SNR even though the signal may be decreased. Therefore, a suitable range of current density for passing through the read sensor 46 in accordance with the invention is about 1.0×10⁷ A/cm² to about 1.0×10⁹ A/cm². In addition, the distance from an ABS of the sensor 46 to a top surface 43 of the soft underlayer 40 is in the range of about 5 nm to about 100 nm for the magnetic field H to effectively bias the soft underlayer 40 as desired.

Whereas particular embodiments of the invention have been described herein for the purpose of illustrating the invention and not for purpose of limiting the same, it will be appreciated by those of ordinary skill in the art that numerous variations of the details, materials, and arrangements of parts may be made within the principle and scope of the invention without departing from the invention as described herein and in the appended claims.

What is claimed is:

1. A perpendicular magnetic recording head for use in conjunction with a perpendicular magnetic recording medium having a soft magnetic underlayer, comprising:
a read head including means for generating a magnetic field to bias the magnetization of the soft magnetic underlayer during a read operation of the perpendicular recording head.

2. The perpendicular magnetic recording head of claim 1, wherein said means for generating a magnetic field includes a current perpendicular to the plane read sensor.

3. The perpendicular magnetic recording head of claim 1, wherein the magnetic field is greater than about 25 Oe for biasing the magnetization of the soft magnetic underlayer.

4. The perpendicular magnetic recording head of claim 2, wherein a current density in the range of about 1.0×10⁷ A/cm² to about 1.0×10⁹ A/cm² is passed through said read sensor.

5. The perpendicular magnetic recording head of claim 2, further including at least one magnetic shield positioned adjacent said read sensor, said at least one magnetic shield serving as a heat sink to provide for increased current density to pass through said read sensor.

6. A magnetic disc drive storage system, comprising:
a perpendicular magnetic recording medium including a soft magnetic underlayer; and
a perpendicular magnetic recording head positioned adjacent said perpendicular magnetic recording medium, said perpendicular magnetic recording head including a read sensor which generates a magnetic field to bias the magnetization of the soft magnetic underlayer of the perpendicular magnetic recording medium during operation of said perpendicular magnetic recording head.

7. The system of claim 6, wherein said read sensor is a current perpendicular to the plane read sensor.

8. The system of claim 7, wherein a current density in the range of about 1.0×10⁷ A/cm² to about 1.0×10⁹ A/cm² is passed through said sensor.

9. The system of claim 6, wherein the distance from an air-bearing surface of said read sensor to a top surface of said soft magnetic underlayer is in the range of about 5 nm to about 100 nm.

10. The system of claim 6, further including at least one magnetic shield positioned adjacent said read sensor, said at least one magnetic shield serving as a heat sink to provide for increased current density to pass through said read sensor.

11. The system of claim 6, wherein said magnetic field generated by said read sensor magnetically biases the magnetization of the soft magnetic underlayer in a substantially radial cross-track direction.

12. A method of using a perpendicular magnetic recording head, having a read sensor, to magnetically bias a soft magnetic underlayer of a perpendicular magnetic recording medium, comprising:
positioning the read sensor adjacent the recording medium; and
passing an electrical current through the read sensor which generates a magnetic field to magnetically bias the soft magnetic underlayer to reduce noise from the soft magnetic underlayer during a read operation of the recording head.

13. The method of claim 12, further including controlling the amount of electrical current passing through the read sensor to control the magnitude of the magnetic field to magnetically bias the soft magnetic underlayer.

14. The method of claim 12, further including adjusting the magnetic field to maximize signal-to-noise ratio during a readback process.

15. The method of claim 12, wherein the electrical current passed through the read sensor has a current density in the range of about 1.0×10⁷ A/cm² to about 1.0×10⁹ A/cm².

16. The method of claim 12, wherein the read sensor is a current perpendicular to the plane read sensor.

17. The method of claim 12, further including maintaining the distance from an air-bearing surface of said read sensor to a top surface of said soft magnetic underlayer in the range of about 5 nm to about 100 nm.

18. The method of claim 12, further including biasing the magnetization in a substantially radial cross-track direction.

19. The method of claim 12, wherein the magnetic field has a value of greater than about 25 Oe to bias the soft magnetic underlayer.

20. The method of claim 12, further including determining the value of the magnetic field for biasing based on the magnetic properties of the soft magnetic underlayer.
